(19) United States
(12) Patent Application Publication
(10) Pub. No.: US 2024/0372297 A1
(43) Pub. Date: Nov. 7, 2024

(54) CONNECTOR ASSEMBLY WITH A TERMINAL POSITION ASSURANCE FUNCTION INTEGRATED TO A CONNECTOR POSITION ASSURANCE MEMBER

(71) Applicant: Aptiv technologies AG, Schaffhausen (CH)

(72) Inventors: Romain SAVINA, Bréthencourt (FR); Uvaraj GANESAN, Chennai (IN); Sylvain LOAS, Saint Denis (FR); Laurent DELESCLUSE, SAINTPIAT (FR)

(21) Appl. No.: 18/652,057

(22) Filed: May 1, 2024

(30) Foreign Application Priority Data
May 1, 2023 (IN) 202341030991

(51) Int. Cl. H01R 13/631; H01R 13/436; H01R 13/641; H01R 43/26

(52) U.S. Cl. CPC H01R 13/631; H01R 13/4367; H01R 13/641; H01R 43/26

(57) ABSTRACT

A connector assembly including a connector and a counter-connector, the connector including a connector housing, at least one terminal, configured to be inserted in a cavity formed in the connector housing, and a CPA member slidably mounted onto the connector housing between an initial position, an intermediate position and a final position, the movement of the CPA member between the intermediate position and the final position being released by the mating of the connector with the counter-connector. The CPA member integrates a TPA element configured to move with the CPA member between a release position, in which the TPA element allows the at least one terminal to be fully inserted in its respective cavity, and a locking position, in which the TPA element locks the at least one terminal fully inserted in its respective cavity. A method for assembling such connector and counter-connector is also disclosed.

### CROSS-REFERENCE TO RELATED APPLICATION

This application claims the benefit of and priority to Indian patent application No. 202341030991 titled “A Connector Assembly with a TPA Function Integrated to a CPA Member” filed on May 1, 2023, the contents of which are incorporated by reference herein.

### TECHNICAL FIELD

The present disclosure in general relates to establishing secure locking of electrical connectors and electrical terminals. More particularly, the disclosure relates to terminal connecting and alignment mechanism having a connector position assurance (CPA) member with an integrated terminal position assurance (TPA) feature.

### BACKGROUND

Generally, electrical connectors require secure mechanical and electrical engagement between one electrical connector and another corresponding electrical connecting device (e.g., a counter-connector) using various latching systems. The connector position assurance (CPA) and terminal position assurance (TPA) functions are important considerations in the design and the implementation of electrical connectors to ensure that they are reliable, secure, and perform their intended use such as receiving and engaging electrical terminals. An example of connector assembly including CPA and TPA functions is disclosed in the International Patent Application published under the number WO 2010/032088 A1.

The CPA and TPA functions may be achieved in a variety of ways, but there is further room for improvement in the existing electrical connectors. Therefore, the inventors felt the need to develop an improved terminal connector assembly.

### SUMMARY

Accordingly, it is disclosed below an improved terminal connector assembly wherein a CPA member is provided with an integrated TPA function.

This connector assembly includes a connector and a counter-connector. The connector includes a connector housing (e.g., a female connector housing), at least one terminal (e.g., a female terminal), configured to be inserted in a cavity formed in the connector housing, and a CPA member slidably mounted onto the connector housing, between (e.g., successively) an initial position, an intermediate position and a final position. The movement of the CPA member between the intermediate position and the final position is released by the mating of the connector with the counter-connector. Further, the CPA member integrates a TPA element configured to move with the CPA member at least between a release position, in which the TPA element allows the at least one terminal to be fully inserted in its respective cavity, and a locking position, in which the TPA element locks the at least one terminal when the latter is fully inserted in its respective cavity.

In other words, this disclosure relates to a connector having a uniquely fabricated CPA mechanism with an integrated TPA function which eliminates the requirement of a separate TPA element, thus saving assembly and operating times. Other objects are for example to allows for fewer parts to be manufactured and to be managed in terms of logistics and inventory.

Advantageously, this electrical connector possibly includes one or more of the following features, each one of these features being considered independently of each other or in combination of one or several others.
the initial position and final position of the CPA member correspond to the release position and the locking position of the TPA element, respectively; the CPA and TPA are activated/disactivated in synchrony with a single connector component;
the connector housing includes a terminal locking latch configured to engage the at least one terminal in its respective cavity, so as to act as primary locking means, and the TPA element in the locking position prevents the terminal locking latch from releasing the at least terminal, so as to act as secondary locking means; as a result, the integrated TPA not only ensures that the terminals are correctly and fully inserted in their respective cavities, but it also provides an additional function, that of providing secondary locking means;
the TPA element is configured so as to free a space above a portion of the terminal locking latch, when the TPA element is in release position, this space being configured to allow the at least one terminal to be released with a tool inserted in the cavity; for example, this space allows to lift the latch;
the TPA element includes a beam integrally formed with a front portion of the CPA member, this beam joining two side flanges of the CPA member, thereby strengthening the CPA member structure; advantageously this beam extends transversally over several terminal cavities;
the CPA member includes a CPA activation arm having a free end located behind the beam with respect to the front portion of the CPA member;
the connector housing includes a connector locking latch which is configured to pivot, when the CPA member is in initial or intermediate position, so as to release the connector from the counter-connector, and which is blocked by the CPA member, when the CPA member is in final position, so as to prevent the connector from being released from the counter-connector;
when the CPA member is in intermediate position, the TPA element is in a pre-lock position in which it locks the at least one terminal fully inserted in its respective cavity.

According to another aspect, it is disclosed below a method for assembling a connector to a counter-connector, the connector including a connector housing, at least one terminal, a CPA member, a TPA element being integrally formed with the CPA member, the method including the steps of
a) inserting the CPA member in CPA guiding means integrally formed with the connector housing,
b) positioning the CPA member in an intermediate position,
c) mating the connector with the counter-connector,
d) positioning the CPA member in a final position, and

the method further including a step e), before or after the step a), of inserting at least one terminal in a cavity formed in the connector housing, a TPA element integral with the CPA member contributing to lock the at least one terminal in the cavity, when the CPA member is in the final position.

Optionally, in this method, the TPA element also locks the at least one terminal in the cavity, when the CPA member is in the intermediate position.

### BRIEF DESCRIPTION OF THE DRAWINGS

The present invention is now described, by way of example with reference to the accompanying drawings, in which:

FIG. 1 is a schematic representation in perspective of an example embodiment of connector assembly (in mating conditions) according to some embodiments.

FIG. 2 is a schematic exploded perspective view of the female connector of the example of connector assembly shown in FIG. 1 according to some embodiments.

FIG. 3 is a schematic perspective view of the CPA member shown in FIG. 2 according to some embodiments.

FIG. 4 is a schematic perspective view of the CPA member shown in FIG. 2, the CPA element being viewed at a different angle to FIG. 3 according to some embodiments.

FIG. 5 is a schematic perspective view similar to FIG. 2, showing only the CPA member and the connector housing according to some embodiments.

FIG. 6 is a schematic perspective view similar to FIG. 5, the CPA being mounted in the CPA guiding means, in initial position according to some embodiments.

FIG. 7 shows a detail of positioning means, when the CPA is in initial position according to some embodiments.

FIG. 8 is a schematic perspective cross section (along the dotted line of FIG. 6—in a lateral longitudinal plane) of the CPA member shown in FIG. 6 according to some embodiments.

FIG. 9 shows details of the TPA element when the CPA member shown in FIGS. 6 and 8 according to some embodiments.

FIG. 10 is a schematic perspective cross section (along the dotted line shown in FIG. 6—in a lateral longitudinal plane) of the CPA member FIGS. 6 and 8, the terminals being in an early stage of their insertion into their respective cavities according to some embodiments.

FIG. 11 is a schematic perspective cross section, similar to FIGS. 8 and 10, the terminals not being fully inserted in their respective cavities according to some embodiments.

FIG. 12 is an enlargement of a detail of FIG. 11 according to some embodiments.

FIG. 13 is a schematic perspective cross section, similar to FIGS. 8, 10 and 11, the terminals being fully inserted in their respective cavities according to some embodiments.

FIG. 14 is an enlargement of a detail of FIG. 13 according to some embodiments.

FIG. 15 is a schematic perspective view of the of the female connector of the example of connector assembly shown in FIG. 1, with the CPA member in initial position, and the terminals being fully inserted in their respective cavities according to some embodiments.

FIG. 16 is a schematic perspective cross section, similar to FIGS. 8, 10, 11 and 13, with the CPA member in intermediate position, and the terminals being fully inserted in their respective cavities according to some embodiments.

FIG. 17 is an enlargement of a detail of FIG. 16 according to some embodiments.

FIG. 18 is a schematic perspective view of the of the female connector, similar to FIG. 15, with the CPA member in intermediate position, and the terminals being fully inserted in their respective cavities according to some embodiments.

FIG. 19 is an enlargement of a detail of FIG. 18 according to some embodiments.

FIG. 20 is a schematic perspective cross section, (along the dotted line shown in FIG. 18—in a median longitudinal plane) of a portion of the connector shown in FIG. 18 according to some embodiments.

FIG. 21 is a schematic perspective view of the connector assembly of FIG. 1, in un-mating conditions according to some embodiments.

FIG. 22 is a schematic perspective cross section, (along the dotted line shown in FIG. 18—in a median longitudinal plane) of the connector assembly of FIG. 1, in partially mating conditions), with the CPA member in intermediate position, and the terminals fully inserted in their respective cavities according to some embodiments.

FIG. 23 is an enlargement of a detail of FIG. 22 according to some embodiments.

FIG. 24 is a schematic perspective cross section, similar to FIG. 22, in fully mated conditions, with the CPA member in intermediate position, and the terminals fully inserted in their respective cavities according to some embodiments.

FIG. 25 is an enlargement of a detail of FIG. 24 according to some embodiments.

FIG. 26 is a schematic perspective cross section, similar to FIGS. 22 and 23, in fully mated conditions, with the CPA member in final position, and the terminals fully inserted in their respective cavities according to some embodiments.

FIG. 27 is an enlargement of a detail of FIG. 26 according to some embodiments.

FIG. 28 shows schematically and in perspective a detail of the positioning means, when the connector assembly is the configuration shown in FIG. 26 according to some embodiments.

FIG. 29 is similar to FIG. 24 according to some embodiments.

FIG. 30 is similar to FIG. 31 according to some embodiments.

FIG. 31 is similar to FIG. 18 according to some embodiments.

FIG. 32 is similar to FIG. 15 according to some embodiments.

FIG. 33 is a schematic perspective cross section, similar to FIG. 13, but with terminals slightly removed from their respective cavities according to some embodiments.

FIG. 34 is an enlargement of a detail of FIG. 33 according to some embodiments.

### DETAILED DESCRIPTION

In this text (in particular in the specification and claims), the orientations and the adverbs such as above, below, etc. refer to the respective orientations of the connector parts shown in the figures.

According to an example embodiment, a terminal connector assembly 1 including a female connector 2 configured to receive female terminals 3 is disclosed below. The female terminals 3 are made by stamping, bending, folding, and possibly plating a sheet of metal (e.g. copper or a copper alloy). For example, these female terminals 3 are of the type marketed under the tradename “APEX® 2.8”.

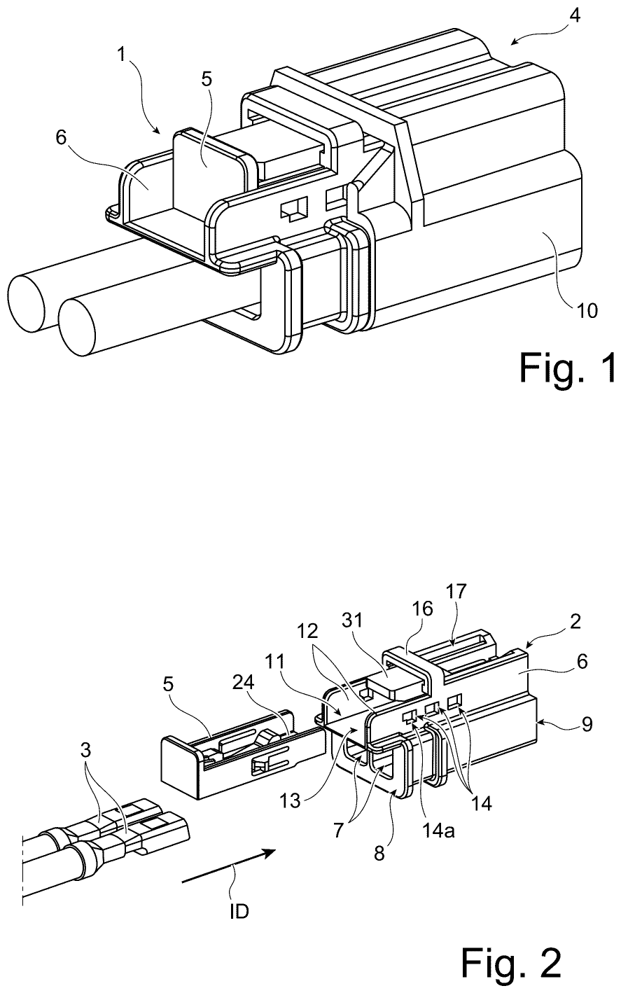

The terminal connector assembly 1 includes the female connector 2 as well as a counter-connector 4 (e.g., a male connector, a male header, etc.). See FIG. 1. The female connector 2 includes female terminals 3 (two female terminals 3 in the illustrated example), a CPA member 5 and a female housing 6. See FIG. 2. For example, the female housing 6 is made of molded plastic. The female housing 6 has a general parallelepipedal shape with cavities 7, each configured to accommodate a female terminal 3. The female housing 6 extends longitudinally, parallel to an insertion direction ID (corresponding to the direction of insertion of each terminal 3 in its respective cavity 7). The female housing 6 extends in the insertion direction ID between a terminal insertion face, or rear face 8, and a front face, or mating face 9. The mating face 9 is configured to be mated with a counter-connector housing 10.

The CPA member 5 is attached with the female housing 6. The female housing 6 includes CPA guiding means 11. The CPA guiding means 11 includes a pair of longitudinal walls 12 extending in a direction parallel to the insertion direction ID, in a plane perpendicular to an upper face 13 of the female housing 6. The two longitudinal walls 12 define a channel into which the CPA member 5 is inserted, slid, and is maintained. Each longitudinal wall 12 includes three notches 14. These three notches 14 are aligned in a row parallel to the insertion direction ID. The first notch 14a of each row (i.e., the notch the closest from the rear face 8) has a castellated edge with a stop feature 15 (see FIG. 7). The female housing 6 includes a bridge 16 extending, over the channel defined by the two longitudinal walls 12. The bridge 16 extends perpendicular to the insertion direction ID, between the upper edges of two longitudinal walls 12. The female housing 6 includes two rail means 17 extending in a direction parallel to the insertion direction ID. Each rail means 17 is located inwardly, in the channel.

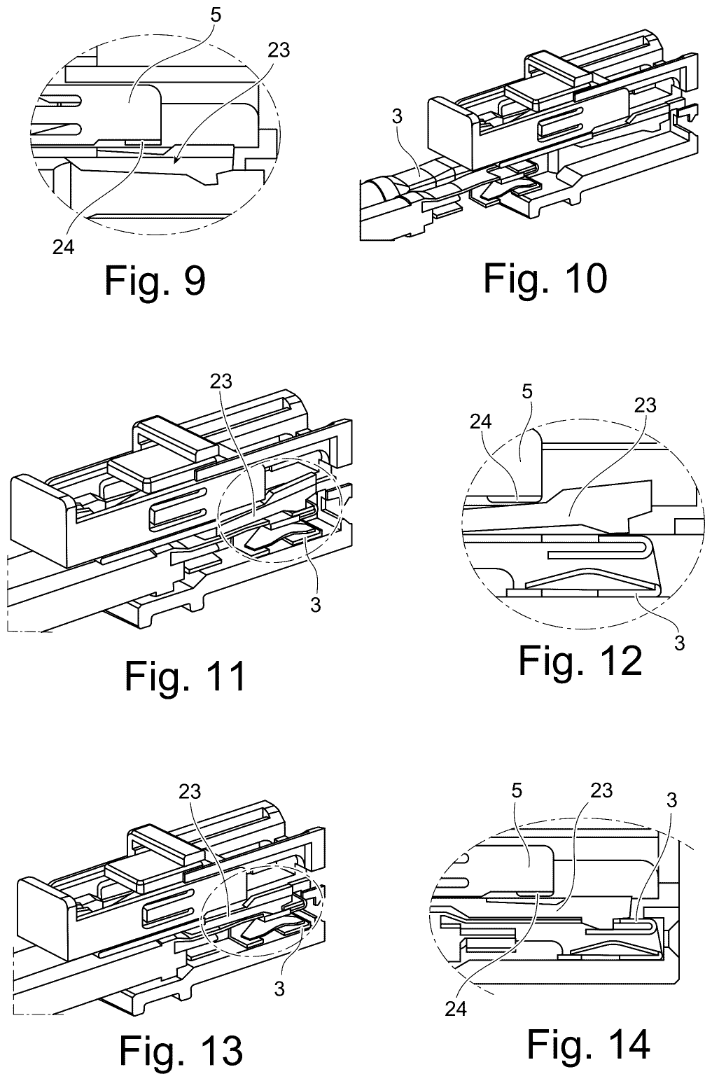

The female housing 6 includes terminal locking latches 23. Each terminal locking latch 23 is configured to provide primary locking means of each terminal 3 in its respective cavity 7 (see FIGS. 9 and 11 to 14).

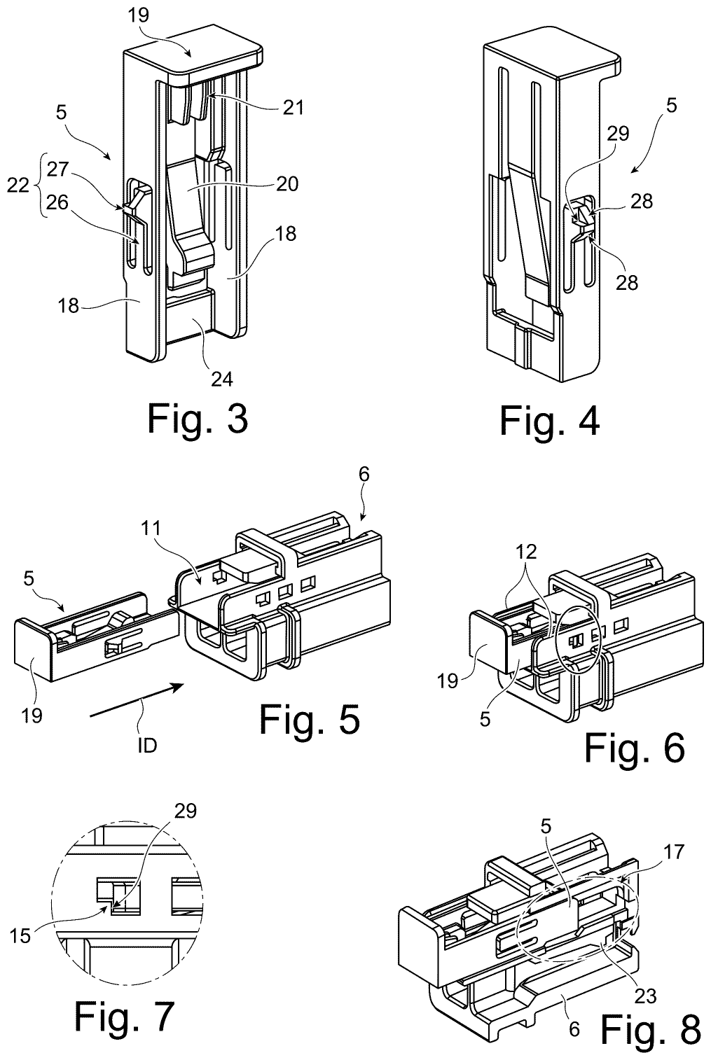

The CPA member 5 incorporates the TPA function and is manufactured as a unitary component. The CPA member 5 is made of molded plastic. The CPA member 5 is made as a slider and includes at least a pair of longitudinal side flanges 18, actuating means 19, a CPA activation arm 20, blocking means 21, CPA locking latches 22 and a TPA element 24 (see FIGS. 3 and 4). The TPA element 24 has a beam shape extending between the longitudinal side flanges 18 in front of the CPA member 5.

In order to mount the CPA member 5 with the female housing 6, first the CPA member 5 is aligned with the female housing 6 along the insertion direction ID (see FIG. 5). The CPA member 5 is then slidably inserted within guiding means 11 provided on the upper face 13 of the female housing 6, through a rear opening of the female housing 6. Pushing on the actuating means 19 in a direction from the rear face 8 to the mating face 9 of the female housing 6 causes the CPA to move between the two longitudinal walls 12 (See FIG. 6).

When the CPA member 5 is mounted in the CPA guiding means 11, each side flanges 18 extends parallel to the insertion direction ID, from the actuating means 19 towards a free end. Each side flange 18 is partially inserted, slid, and is maintained in a respective rail means 17 (see FIG. 8). Each longitudinal side flange 18 supports a CPA locking latch 22 (see FIGS. 3 and 4). More particularly, each CPA locking latch 22 is in the form of a flexible arm 26 fitted with a tooth 27. Each flexible arm 26 extends longitudinally parallel to the side flange 18 which supports it, from a joint (on the free end side of the side flange 18) to the tooth 27 (on the actuating means side). Each tooth 27 extends outwardly from the end of the flexible arm 26. Each tooth 27 has a slanted surfaces 28 and a blocking surface 29 perpendicular to the insertion direction ID (when the CPA member 5 is mounted with the female housing 6).

Each CPA locking latch 22 is configured to engaged in notches 14 of the female housing 6. The notches 14 provide positioning means of the CPA member 5 in the guiding means 11. Successively, the CPA member 5 can be positioned in an initial position, in an intermediate position and in a final position, when each tooth 27 passes from one notch 14 to the next one in the insertion direction ID. In the initial position of the CPA member 5 (as shown in particular in FIGS. 6 and 7), each CPA locking latch 22 engages a first notch 14a. In this position, each blocking surface 29 engages a stop feature 15, thereby allowing to insert the CPA member 5 in a restrictive manner (i.e., in preventing the CPA member 5 to be easily removed from the CPA guiding means 11). In other words, the blocking surface 29 of each tooth 27 engages the stop feature 15 of a first notch 14a so as to prevent the CPA member 5 from being removed from the female housing 6 in a direction opposite to the insertion direction ID.

In the initial position of the CPA member 5, the TPA element 24 is in release position (see FIGS. 9, 12 and 14, for example). In this position, each terminal 3 can be inserted in its cavity 7 successively from the position illustrated in FIG. 10 (early stage of their insertion), to the position illustrated in FIGS. 11 and 12 (terminal 3 not fully inserted) and last to the position illustrated in FIGS. 13 and 14 (terminal 3 fully inserted). During this insertion of the terminals 3, the CPA member 5 is left in its initial position where the TPA element 24 leaves a room or space for each terminal locking latch 23 to be upwardly deflected (see FIGS. 8 to 12).

In other words, while a terminal 3 is inserted in its cavity 7, an end portion of the corresponding terminal locking latch 23 is elastically pushed upwards (see FIG. 12). When, this terminal 3 is fully inserted in its cavity (i.e., in its functional position), the corresponding terminal locking latch 23 returns elastically to its unstressed rest position, in which a stop of the terminal locking latch 23 cooperates with a recess in this terminal 3 to ensure a primary locking of the terminal 3 to prevent this terminal 3 from being removed from its cavity. (see FIGS. 13 to 14).

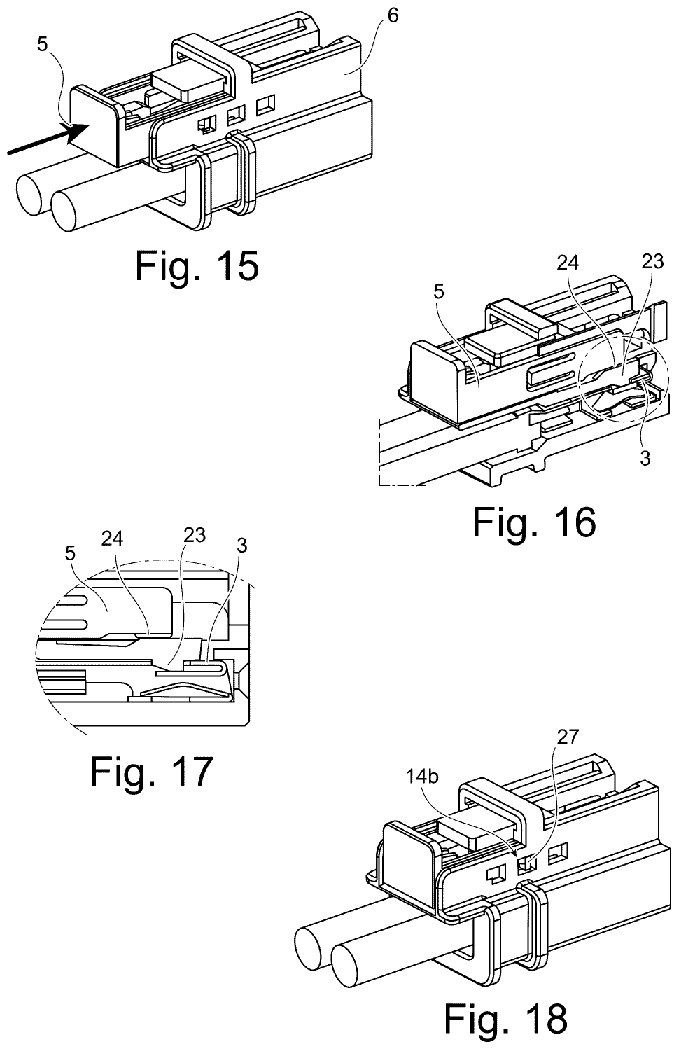

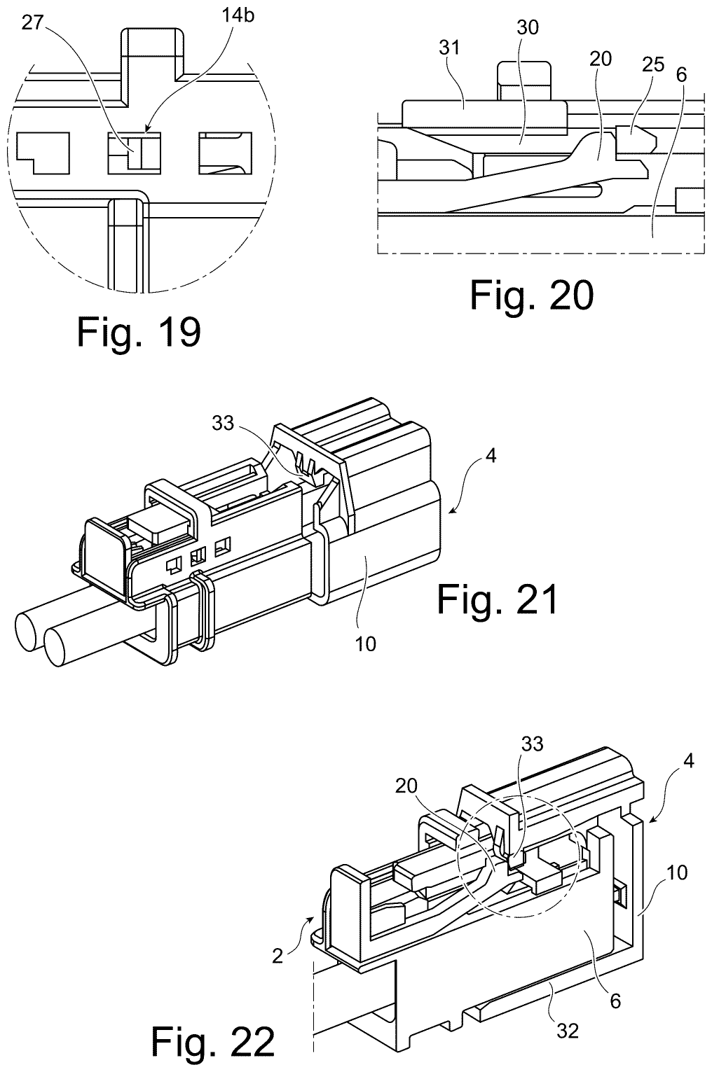

After insertion of the terminal 3, the CPA member 5 is further inserted within the female housing 6, up to a position where the TPA element 24 is in a pre-position (from the position illustrated by FIG. 15 up to the position illustrated by FIGS. 16 to 20). For example, the CPA member 5 is further inserted a distance of 4 mm along the insertion direction ID. In this condition, the terminal locking latch 23 is protected by the TPA element 24 by pressing against it. Thereby, the terminal locking latch 23 is prevented from being deflected upwards. Therefore, the TPA element provides secondary locking means. The CPA member 5 is locked in intermediate position thanks to the teeth 27, each engaging a respective second notch 14b (see FIGS. 18 and 19).

Further, the CPA activation arm 20 presses against the female connector housing 6 (Sec FIG. 20). More particularly, the female connector housing 6 includes a resilient beam 25 against which abuts the CPA activation arm 20 (see FIG. 20). More particularly, the resilient beam 25 extends transversally (perpendicular to the insertion direction ID) at a free end of a pivoting connector locking latch 30. The connector locking latch 30 also includes an actuating tongue 31 (see FIG. 21). Downward pressure on the actuating tongue 31 lowers the resilient beam 25 upwards (when the CPA element 5 is in the initial or intermediate position).

The CPA activation arm 20 abuts the resilient beam 25 as long as a counter-connector 4 is not mated to the connector 2 (or as long as the actuating tongue 31 is not pressed downward).

For example, the counter-connector connector housing 10 has a skirt 32 or a flange into which the mating face 9 of the female housing 6 is received. For example, the skirt 32 covers partially a front portion of the female housing 6 (see FIG. 22).

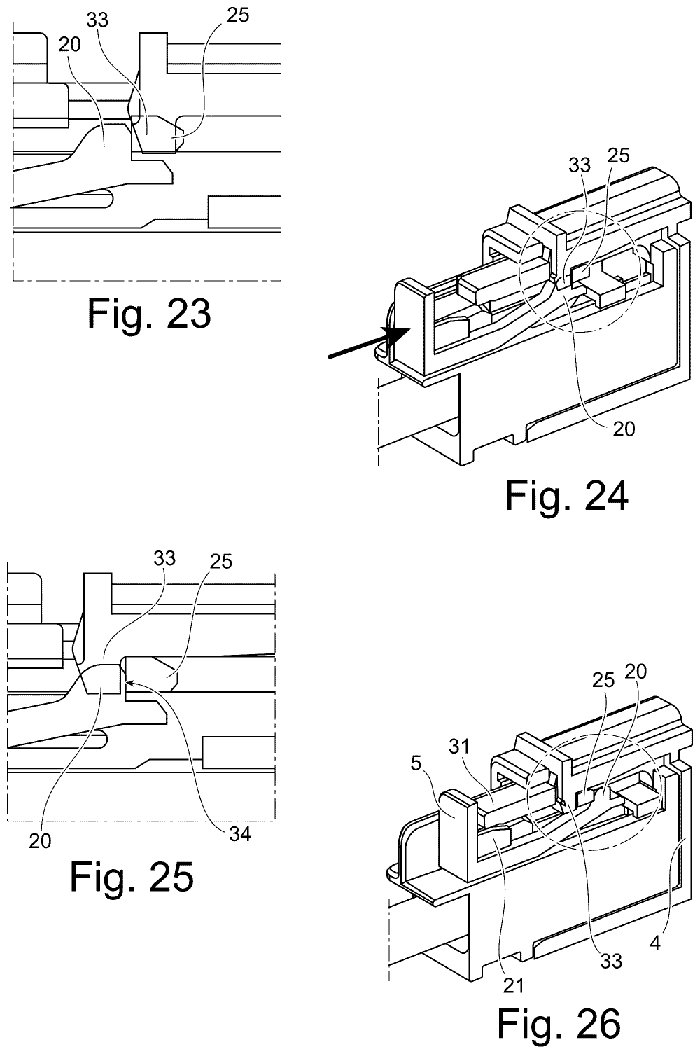

When the female connector 2 is mated to a counter-connector 4 (e.g., a male connector), CPA unlocking means 33 located on the counter-connector housing 10 presses first, the resilient beam 25 (See FIGS. 22 and 23) and second, the CPA activation arm 20 (See FIGS. 24 and 25). In the conditions illustrated by FIGS. 24 and 25, the female connector 2 is fully mated to the counter-connector 4. The female connector 2 and the counter-connector 4 are fastened to each other by the engagement of a stop surface 34, located on the counter-connector housing 10, with the resilient beam 25 (See FIG. 25). The resilient beam 25 acts as a latch to lock the male 4 and female 2 connectors together.

In the position illustrated by FIGS. 24 and 25, the CPA activation arm 20 is pressed downward by the CPA unlocking means 33 of the counter-connector housing 10. The FIGS. 22 to 25 are not entirely realistic in the sense that the CPA activation arm 20 should be shown as being deflected and the resilient beam 25 or free end of the CPA activation arm 20 should be shown should below the stop surface 34.

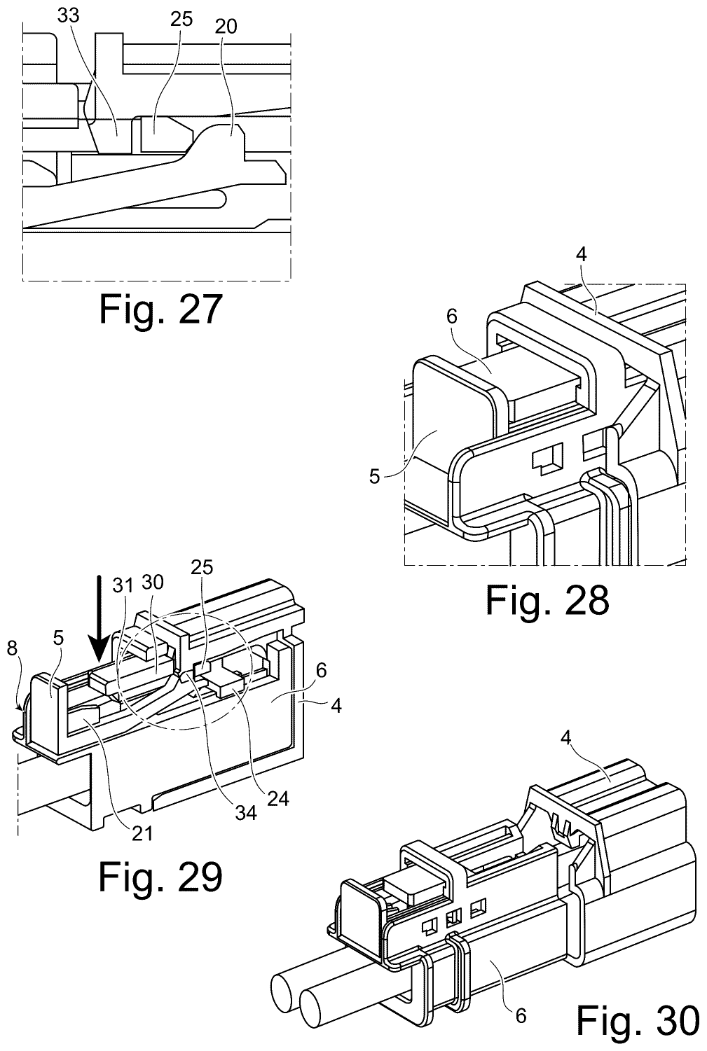

As the CPA member 5 is moved from its intermediate position to its final position (FIGS. 26 to 28), the CPA activation arm 20 passes below the resilient beam 25, and springs back behind it (see FIGS. 26 and 27). The CPA activation arm 20 is thus activated when pressed by the CPA unlocking means 33 of the counter-connector 4. As the CPA member 5 is moved from its intermediate position to its final position, the TPA element 24 still presses the terminal locking latch 23. The TPA element 24 is in its locking position.

Further, when the CPA member 5 is in its final position, the CPA blocking means 21 prevents the connector locking latch 30 to be depressed if the actuating tongue 31 is pressed downward (see FIG. 26). The connector 2 and the counter-connector 4 are then securely mated and locked together.

To un-mate the connector 2 and the counter-connector 4, the CPA member 5, is slid out a distance (e.g., of 4 mm) from its final position in an outwards direction (opposite the insertion direction ID) towards the rear face 8 of the female housing 6. As the CPA member 5 is moved this way, the CPA member 5 is in intermediate position and the TPA element 24 reaches its pre-locked position (See FIG. 29). In this position of the CPA member 5, the CPA blocking means 21 is no longer below the actuating tongue 31.

To un-mate the connector 2 from the counter-connector 4, the actuating tongue 31 is depressed. Thereby, the connector locking latch 30 pivots and the resilient beam 25 is moved downward (so as pass below the stop surface 34) and releases connector 2 from the counter-connector 4 (Sec FIG. 29). The connector 2 can be removed from the counter-connector 4 (Sec FIG. 30).

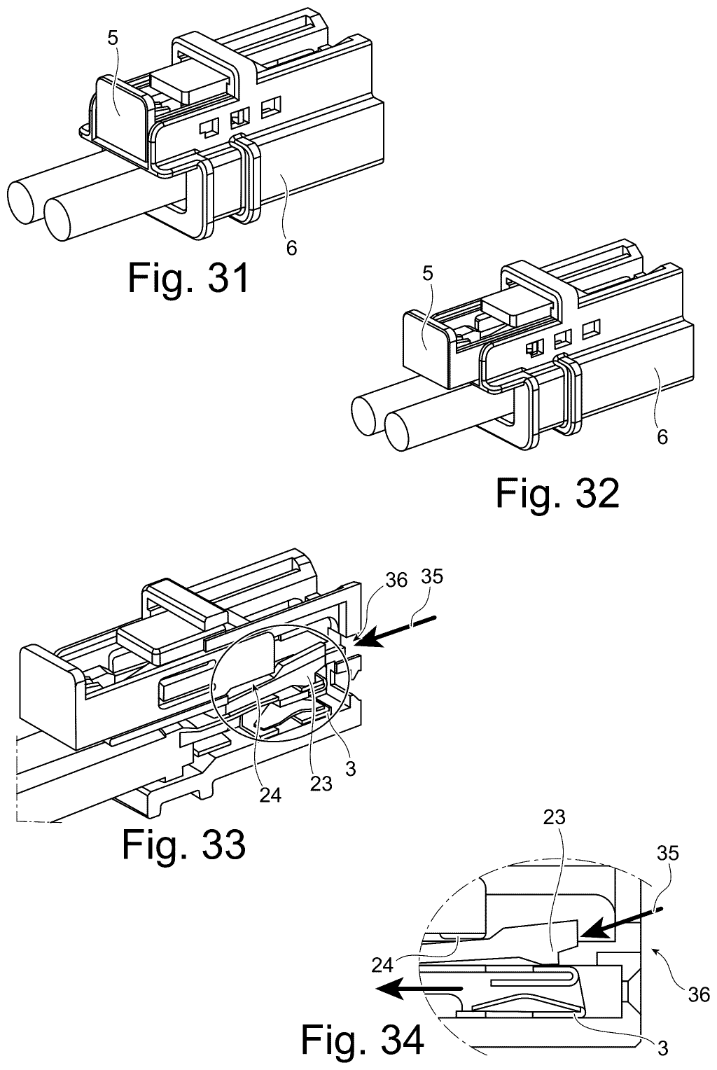

In order to remove the terminals 3 from their respective cavities 7, the CPA member 5 is further pulled out (e.g., of 4 mm) from its intermediate position illustrated by FIG. 31 to its initial position illustrated by FIG. 32. When the CPA member 5 reaches its initial position, the TPA element TPA 24 reaches its release position in which space is cleared above the terminal locking latches 23. The terminal locking latches 23 can be deflected. Next, tools 35 can be inserted in predefined slots 36 of the female housing 6 to deflect the locking latches 23 and unlock the terminals 3, after which the terminals 3 are removed from the female connector housing (See FIGS. 33 and 34).

Numerous versions of the design described above are possible. For example, on or more of the initial, intermediate, and final positions of the CPA member 5 can be shifted relatively to the release position and the locking position of the TPA element 24 (for example, more notches can be provided in the longitudinal walls 12).

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if”′ is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector assembly comprising a connector and a counter-connector, the connector comprising:
a connector housing;
at least one terminal, configured to be inserted in a cavity formed in the connector housing; and
a CPA member slidably mounted onto the connector housing between an initial position, an intermediate position and a final position, wherein movement of the CPA member between the intermediate position and the final position is released by mating the connector with the counter-connector and wherein the CPA member integrates a TPA element configured to move with the CPA member at least between a release position, in which the TPA element allows said at least one terminal to be fully inserted in its respective cavity, and a locking position, in which the TPA element locks said at least one terminal fully inserted in its respective cavity.

2. The connector assembly according to claim 1, wherein the initial position and final position of the CPA member correspond to the release position and the locking position of the TPA element, respectively.

3. The connector assembly according to claim 1, wherein the connector housing comprises a terminal locking latch configured to engage said at least one terminal in its respective cavity so as to act as primary locking means and the TPA element in the locking position prevents the terminal locking latch from releasing said at least one terminal, so as to act as secondary locking means.

4. The connector assembly according to claim 3, wherein the TPA element is configured so as to free a space above a portion of the terminal locking latch, when the TPA element is in release position, this space being configured to allow said at least one terminal to be released with a tool inserted in said cavity.

5. The connector assembly according to claim 1, wherein the TPA element comprises a beam integrally formed with a front portion of the CPA member.

6. The connector assembly according to claim 5, wherein the CPA member comprises a CPA activation arm having a free end located behind the beam with respect to the front portion of the CPA member.

7. The connector assembly according to claim 1, wherein the connector housing comprises a connector locking latch which is configured to pivot, when the CPA member is in initial or intermediate position, so as to release the connector from the counter-connector, and which is blocked by the CPA member, when the CPA member is in final position, so as to prevent the connector from being released from the counter-connector.

8. The connector assembly according to claim 1, wherein, when the CPA member is in intermediate position, the TPA element is in a pre-lock position in which it locks said at least one terminal fully inserted in its respective cavity.

9. A method for assembling a connector to a counter-connector, the connector comprising a connector housing, at least one terminal, a CPA member, a TPA element being integrally formed with the CPA member, the method comprising:
a) inserting the CPA member in CPA guiding means integrally formed with the connector housing;
b) positioning the CPA member in an intermediate position;
c) mating the connector with the counter-connector;
d) positioning the CPA member in a final position; and
e) inserting at least one terminal in a cavity formed in the connector housing wherein step e) is performed before or after step a) and wherein a TPA element integral with the CPA member contributes to lock said at least one terminal in the cavity, when the CPA member is in the final position.

10. The method of claim 9, wherein the TPA element also locks said at least one terminal in the cavity, when the CPA member is in the intermediate position.
